(19) United States
(12) Patent Application Publication
(10) Pub. No.: US 2013/0084400 A1
(43) Pub. Date: Apr. 4, 2013

(54) SUBSTRATE PROCESSING METHOD

(71) Applicants: Masako KODERA, Yokohama-shi (JP); Gaku Minamihaba, Yokohama-shi (JP)

(72) Inventors: Masako KODERA, Yokohama-shi (JP); Gaku Minamihaba, Yokohama-shi (JP)

(21) Appl. No.: 13/427,267

(22) Filed: Mar. 22, 2012

(30) Foreign Application Priority Data
Sep. 29, 2011 (JP) 2011-214831

(51) Int. Cl. B05D 1/28; B05C 1/12

(52) U.S. Cl. 427/428.01; 118/258

(57) ABSTRACT

According to one embodiment, a substrate processing apparatus is provided, in which a solvent is supplied onto a surface of a substrate having trenches made in a surface, and the substrate is rotated while a solvent holding member made of plastic material is contacting the surface of the substrate, whereby the surface of the substrate and the solvent holding member slide on each other.

### CROSS-REFERENCE TO RELATED APPLICATIONS

This application is based upon and claims the benefit of priority from prior Japanese Patent Application No. 2011-214831, filed Sep. 29, 2011, the entire contents of which are incorporated herein by reference.

### FIELD

Embodiments described herein relate generally to a substrate processing method.

### BACKGROUND

In manufacturing, for example, a semiconductor device, a method is performed, in which insulating films and interconnect films are filled in fine pattern trenches, thereby forming insulating film patterns and interconnect layer patterns. In the shallow trench isolation (STI) step performed to isolate elements by, for example, photolithography and reactive ion etching (RIE) are first performed, thereby forming a trench pattern in the surface of a silicon substrate, and chemical vapor deposition (CVD), for example, is then performed, thereby forming an SiO₂ film. Thereafter, those parts of the SiO₂ film, which exist outside the trenches, are removed by chemical mechanical planarization (CMP). An insulating layer pattern, i.e., SiO₂ films in the trenches, is thereby obtained.

Any method of this type is, however, disadvantageous in that both a film forming step and a CMP step must be performed and much time is inevitably required. Further, as the design rule advances, accomplishing miniaturization of elements, it is demanded that an air gap structure should be formed in insulating film in order to enhance the device characteristic. However, it is difficult to make the air gap structure by processing that forms the film.

### BRIEF DESCRIPTION OF THE DRAWINGS

FIG. 1 is a perspective view showing the configuration of the substrate processing apparatus (i.e., solvent filling apparatus) used in a substrate processing method according to a first embodiment;

FIG. 2 is a perspective view showing the configuration of the substrate processing apparatus used in a substrate processing method according to a second embodiment;

FIG. 3 is a perspective view showing the configuration of the substrate processing apparatus used in a substrate processing method according to a third embodiment;

FIGS. 4A and 4B are sectional views showing steps of manufacturing a semiconductor device according to a fourth embodiment;

FIG. 5 is a photo-micrograph explaining the advantage of the fourth embodiment, and showing the filling state in trenches;

FIGS. 6A and 6B are sectional views showing steps of manufacturing a semiconductor device according to a comparative example;

FIGS. 7A to 7C are sectional views showing steps of manufacturing a semiconductor device according to a fifth embodiment; and

FIG. 8 is a perspective view showing the configuration of the substrate processing apparatus used in a substrate processing method according to a modified embodiment.

### DETAILED DESCRIPTION

In general, according to one embodiment, a substrate processing method is provided, in which a solvent is supplied to a surface of a substrate having trenches made in the surface, a solvent holding member made of elastic material is set in contact with the surface of the substrate, and the substrate is rotated, making the solvent holding member slide on the surface of the substrate.

Embodiments will be explained in detail, with reference to the accompanying drawings.

### First Embodiment

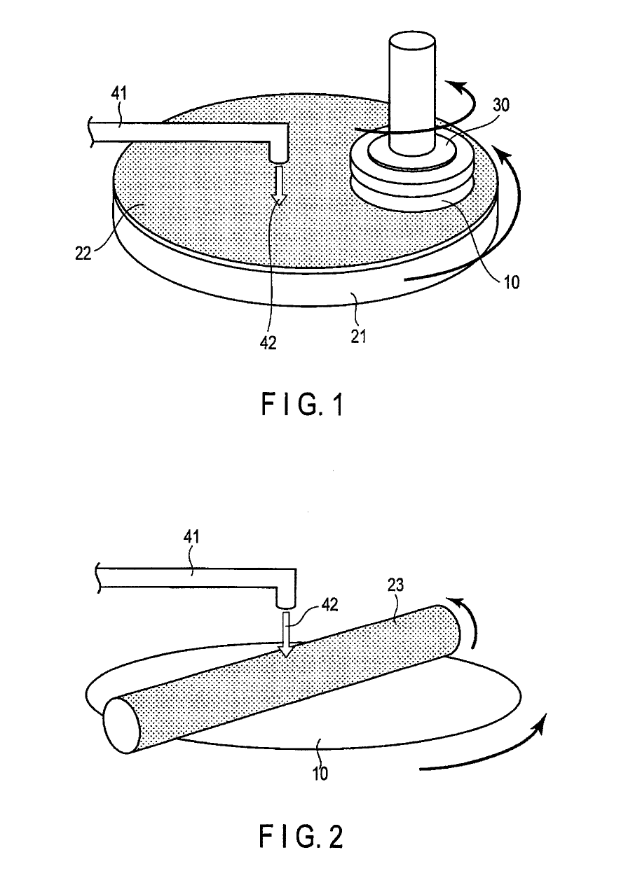

FIG. 1 is a perspective view showing the configuration of the substrate processing apparatus (i.e., solvent filling apparatus) used in a substrate processing method according to a first embodiment.

In FIG. 1, 10 designates a substrate such as a silicon wafer, 21 designates a disc-shaped surface plate, 22 designates a solvent holding member arranged on the surface of the surface plate 21, 30 designates a disc-shaped holder for holding the substrate 10, 41 designates a solvent supplying nozzle, and 42 designates solvent.

The surface plate 21 can be rotated by a drive mechanism (not shown), on its axis at a rate of, for example, 10 to 100 rpm. The holder 30 has a smaller diameter than the surface plate 21 and can be rotated by a drive mechanism (not shown), on its axis at a rate of, for example, 10 to 200 rpm.

The axis of rotation of the holder 30 is not aligned with the axis of rotation of the surface plate 21, and is displaced from the center of the surface plate 21 in the radial direction. That is, the axis of rotation of the surface plate 21 and the axis of rotation of the holder 30 are parallel and spaced apart. Note that the axis of rotation of the substrate 10 and the axis of rotation of the holder 30 need not be aligned with each other. Therefore, the substrate 10 is rotated around an axis that is perpendicular to the substrate 10.

It is desired that the solvent holding member 22 should be made of material that has fine pores in the surface. Foamed rubber such as polyvinyl alcohol (PVA), foamed polyurethane, unwoven cloth, or epoxy resin pad, for example, can be used as material of the solvent holding member 22. If the solvent 42 has, for example, high viscosity and may likely remain on the surface of the solvent holding member 22, the solvent holding member 22 need not have fine pores at all. The solvent holding member 22, however, must be elastic enough not to damage the substrate 10 even if it is pressed onto the substrate 10. Hence, the solvent holding member 22 should better be made of elastic material.

To acquire plasticity high enough not to damage the substrate 10, the solvent holding member 22 must have hardness equal to or smaller than the hardness of the film on the substrate in which the trench pattern is made. If the solvent holding member 22 has such hardness, it can be a nylon brush.

The solvent supplying nozzle 41 has a port for supplying the solvent 42, which is positioned near the center of the surface plate 21. The solvent 42 can drip from the port of the solvent supplying nozzle 41.

A method of filling the trenches with the solvent by using the apparatus described above will be explained below.

First, the substrate 10 having a trench pattern on the surface is placed on the holder 30, with the surface turned downwards. Then, the surface plate 21 and the holder 30 are rotated together, while the solvent 42 is being supplied from the solvent supplying nozzle 41 to the solvent holding member 22. That is, the rotation of the substrate 10 and solvent holding member 22 and the supplying of the solvent 42 are performed at the same time. Further, the surface of the substrate 10 is brought into contact with the solvent holding member 22.

Since the solvent holding member 22 has a structure having fine pores, the solvent 42 accumulates on the solvent holding member 22 as it is supplied to the solvent holding member 22. Further, as the solvent holding member 22 is rotated, the surface of the substrate 10 and the solvent holding member 22 slide relative to each other. The solvent 42 can thereby be supplied to the surface of the substrate. At this point, not only the solvent holding member 22, but also the substrate 10 is rotated. The solvent holding member 22 can therefore slide on the surface of the substrate 10, more uniformly than otherwise. The solvent 42 can therefore be filled only in the trenches made in the substrate 10, both efficiently and uniformly.

In this case, the solvent 42 fills the trenches only. A CMP process need not be performed as a post process as in the case where the film has been formed by CVD. If the solvent 42 is SOG, polysilazane or the like, insulating film will be formed in the trenches. The solvent 42 can then serve to form STI. Further, since the solvent holding member 22 possesses plasticity, it would not damage the substrate 10.

This embodiment thus uses such a filling apparatus as shown in FIG. 1, rotating the substrate 10 and the solvent holding member 22 and supplying the solvent 42 to the solvent holding member 22. The embodiment can therefore easily fill only the trenches made in the substrate 10 with the solvent that will form insulating films and interconnect films. In this case, the surface of the substrate 10 and the solvent holding member 22 assume a sliding state at all times, and the solvent 42 never remains outside the trenches. Therefore, a post process, such as CMP process, need not be performed as in the case where the trenches are filled with film by means of CVD. This can shorten the manufacturing time and reduce the manufacturing cost. In view of this, this embodiment is useful to form an insulating layer pattern in trenches or an interconnect layer pattern in trenches.

The apparatus shown in FIG. 1 is basically identical in structure to a CMP apparatus for use in manufacturing semiconductor devices. The apparatus can therefore be any existing CMP apparatus. That is, the existing CMP apparatus may be used, supplying from the nozzle a solvent containing the material for filling the trenches, in place of polishing agent. Hence, this embodiment need not use an apparatus dedicated to fill the trenches, and can use an existing apparatus modified a little.

In order to form a spaced structure to the insulating layer provided in each trench, it is useful to use fine particles in the process of filling the trenches. To form this structure, it suffices to contain hollow fine particles in the solvent 42.

To fill the fine particles efficiently in any trench made in the substrate, it is desirable to select fine particles having an average diameter that is equal to or smaller than the width of the trench made in the substrate. To fill solvent containing fine particles in only any trench that has a width equal to or larger than a desirable width, it suffices to use solvent that contains fine particles having a diameter equal to or larger than a designated trench width. Since the fine particles cannot enter any trench that is narrower than the diameter of the fine particles, the solvent containing the fine particles can be selectively filled in only the trenches broader than the designated width. Only the solvent is filled in any trench narrower.

The fine particles may not be spherical. In this case, the size of the fine particles may be based on the minor-axis diameter. The shape of the fine particles contained in the solvent is not limited to spherical or quasi-spherical. The fine particles may be shaped like hollow fibers or may have any irregular shape.

If the fine particles are made of material that attracts the material of the substrate having the trenches, the solvent containing the fine particles can be more efficiently filled than otherwise in the trenches. For example, the zeta potential at the trenches made in the substrate and the zeta potential at the surfaces of the fine particles may be set to opposite polarities. Then, the fine particles can be readily adsorbed and filled in the trenches. Alternatively, if the zeta potential at the trenches or the surfaces of the fine particles is almost zero, the fine particles can be also readily filled in the trenches. Not only the electrical attraction, but also magnetic attraction can be utilized. For example, fine particles having ferromagnetism may be used, and a magnetic force may be applied from behind the substrate. Then, the fine particles can be readily adsorbed and filled in the trenches.

In the embodiment described above, it may be difficult to disperse the fine particles uniformly in the solvent 42. In this case, the fine particles may be contained in other solvent, in which the fine particles are well dispersed. The other solvent containing the fine particles is supplied into each trench, not filling up the trench. Thereafter, the solvent containing no particles is supplied into the trench, filling the trench completely.

The step of supplying the solvent 42 need not be performed at the same the step of filling the trenches is performed. The trenches may be filled with the solvent after the step of supplying the solvent. Alternatively, a part of the step of supplying the solvent and a part of the step filling the trenches may proceed simultaneously or alternately. Moreover, the solvent holding member 22 may rub the surface of the substrate, while applying remover, after the solvent has been supplied, filling the trenches to efficiently, thereby to remove the solvent from outside the trenches.

It may be necessary to remove the solvent, partly or entirely, after filling the trenches. In this case, the solvent may be so removed by means of heating or washing. Further, the solvent and the fine particles need not be filled in each trench to the brim. They may instead fill the trench to a level below the brim. Moreover, the trench pattern need not be composed of trenches. Rather, it may be shaped like holes or spaces of irregular shape, as well.

As described above, the solvent contains fine particles, and the fine particles are made of selected material, having specific electrical conductivity, thermal conductivity and optical characteristic. Thus, the filler in the trenches can be controlled to acquire desirable characteristics. If hollow fine particles, for example, are used, the dielectric constant of the filler can be decreased. The method according to this embodiment may be used in, for example, the STIT step in manufacturing an LSI. Then, can enhance the electrical characteristics of the semiconductor device. Moreover, if electrically conductive fine particles are used, the filler can be used to form interconnects.

If fine particles are contained in the solvent that will change to transparent resin, and if this solvent is filled in pattern trenches, the filler can be controlled in terms of reflectivity, refractive index and transmittance. This is useful if the solvent is used to form optical waveguides. Further, if fibrous fine particles are, the mechanical strength of the filler can be greatly increased.

### Second Embodiment

FIG. 2 is a perspective view showing the configuration of the substrate processing apparatus used in a substrate processing method according to a second embodiment. The components identical to those shown in FIG. 1 are designated by the same reference numbers and will not be described in detail.

A substrate 10 having a trench pattern on the surface is placed on a holder (not shown), with the surface turned upwards. The substrate 10 can be rotated with a driving force applied from the holder. A pillar-shaped solvent holding member 23 the length of which is slightly greater than the diameter of the substrate 10 is arranged above the substrate 10. The solvent holding member 23 can be rotated with a driving force applied from a drive unit (not shown). The axis of rotation of the substrate 10 and the axis of rotation of the solvent holding member 23 are orthogonal to each other. Further, a solvent supplying nozzle 41 is positioned above the solvent holding member 23.

The solvent holding member 23 should better be a roll-type or a small-type. It is desired that the solvent holding member 23 should be made of material that has fine pores in the surface in most cases, as in the first embodiment. A pillar of foamed rubber can be used as the solvent holding member 23. If the solvent 42 is of the type that tends to remain on the surface of the substrate 10, the solvent holding member 23 need not have fine pores at all. The solvent holding member 23 only needs to be elastic enough not to damage the substrate 10 even if it is pressed onto the substrate 10.

The apparatus shown in FIG. 2 is used as follows, in order to fill the trenches with the solvent. The solvent 42 is dripped from the solvent supplying nozzle 41 onto the solvent holding member 23, and the substrate 10 and the solvent holding member 23 are rotated at the same time. The solvent 42 can thereby be supplied from the solvent holding member 23 to the surface of the substrate. The solvent 42 can be uniformly filled in only the trenches made in the substrate 10 at high efficiency.

As a result, insulating films and interconnect films can be easily formed in the trenches, in the same way as in the first embodiment. This can shorten the manufacturing time and reduce the manufacturing cost. If fine particles (not shown) are contained in the solvent 42, the trenches made in the substrate can be filled with the solvent containing the fine particles.

### Third Embodiment

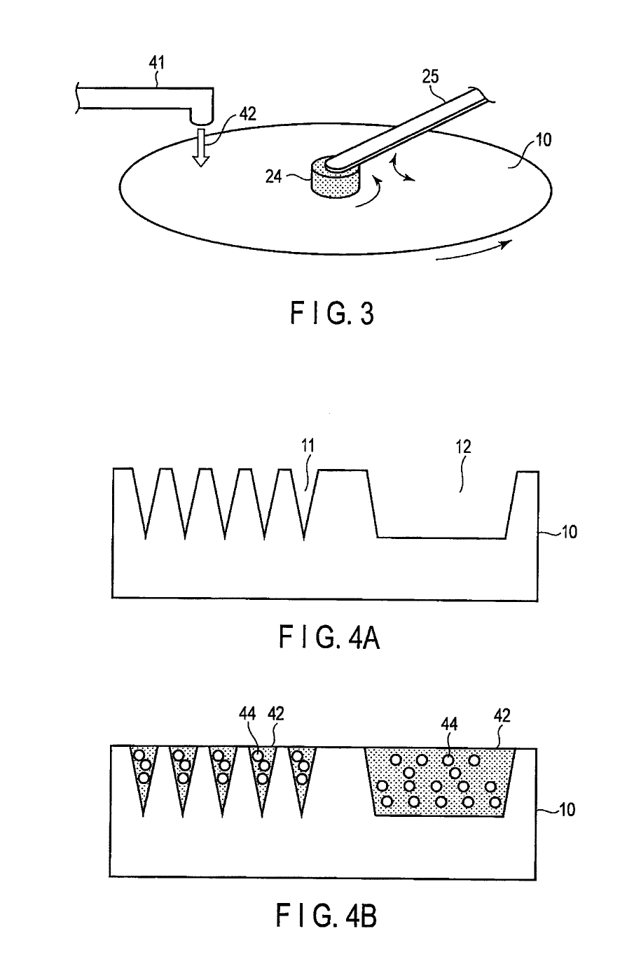

FIG. 3 is a perspective view showing the configuration of the substrate processing apparatus used in a substrate processing method according to a third embodiment. The components identical to those shown in FIG. 1 and FIG. 2 are designated by the same reference numbers, and will not be described in detail.

A substrate 10 having a trench pattern on the surface is placed, with the surface turned upwards, as in the second embodiment. The substrate 10 can be rotated with a driving force applied from a holder (not shown). An arm 25 that can rotate by a prescribed angle is arranged, with its distal end positioned above the substrate 10. A pillar-shaped solvent holding member 24 having a smaller diameter than the substrate 10 is secured to the distal end of the arm 25. The solvent holding member 24 can be rotated with a driving force applied from a drive unit (not shown). The axis of rotation of the substrate 10 and the axis of rotation of the solvent holding member 24 are parallel to each other. Further, a solvent supplying nozzle 41 configured to supply the solvent 42 directly to the surface of the substrate 10 is arranged above the solvent holding member 23.

It is desired that the solvent holding member 24 should be made of material that has fine pores in the surface in most cases, as in the first embodiment. A pillar of foamed rubber can be used as the solvent holding member 24. If the solvent 42 may likely remain on the surface of the substrate 10, the solvent holding member 24 need not have fine pores at all. The solvent holding member 24 only needs to be elastic enough not to damage the substrate 10 even if it is pressed onto the substrate 10.

The apparatus shown in FIG. 3 is used as follows, in order to fill the trenches with the solvent. The solvent 42 is dripped from the solvent supplying nozzle 41 onto the substrate 10, and the substrate 10 and the solvent holding member 24 are rotated at the same time. The solvent 42 can thereby be uniformly filled in only the trenches made in the substrate 10 at high efficiency.

As a result, insulating films and interconnect films can be easily formed in the trenches in the same way as in the first embodiment and the second embodiment. This can shorten the manufacturing time and reduce the manufacturing cost.

### Fourth Embodiment

A semiconductor device manufacturing processing method performed by using the apparatus shown in any one of FIGS. 1 to 3 will be explained with reference to FIGS. 4A and 4B.

First, as shown in FIG. 4A, photolithography (alternatively, RIE) and wet etching are performed, making trenches 11 and 12 in a surface of a silicon substrate 10. The trenches may have various widths. The trenches 11 are narrow, whereas the trench 12 is broad.

The material to fill the trenches 11 and trench 12 will form insulating layers. The solvent 42 used is therefore SOG containing, for example, hollow Si fine particles 44. The fine particles 44 have a diameter of, for example, 50 nm or less. Al₂O₃ fine particles or SiN-based fine particles may be used as hollow particles, in place of Si fine particles. To form interconnect layers, not insulating layers, fine particles of metal oxide or C-based fine particles may be used.

Next, the apparatus shown in FIG. 1 is used. More precisely, the holder 30 holds the substrate 10 with its surface directed downward, and the surface of the substrate 10 is brought into contact with the solvent holding member 22. The surface plate 21 and the holder 30 are rotated together, while supplying the solvent 42 from the solvent supplying nozzle 41 to the solvent holding member 22. As shown in FIG. 4B, the solvent 42 containing the fine particles 44 is thereby uniformly filled, at high efficiency, in the trenches 11 and 12 made in the substrate 10.

At this point, the solvent 42 can be filled in the trenches 11 and 12 at high efficiency if the fine particles 44 have a diameter much smaller than the width of the trenches 11 and the width of the trench 12. In this case, almost no solvent 42 remains outside the trenches 11 and 12. Therefore, a post process, such as CMP process, need not be performed.

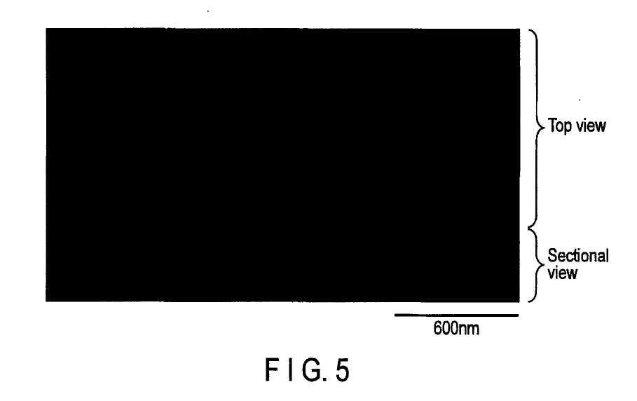

FIG. 5 is a photo-micrograph showing the trenches 11 which are filled with the solvent 42 and the fine particles 44 by the method according to the fourth embodiment. Note that the trenches 11 have a width of 300 nm and are made at pitch of 600 nm. As seen from FIG. 5, the trenches 11 are filled to the brim with the solvent 42a and the fine particles 44 having a diameter of about 50 nm.

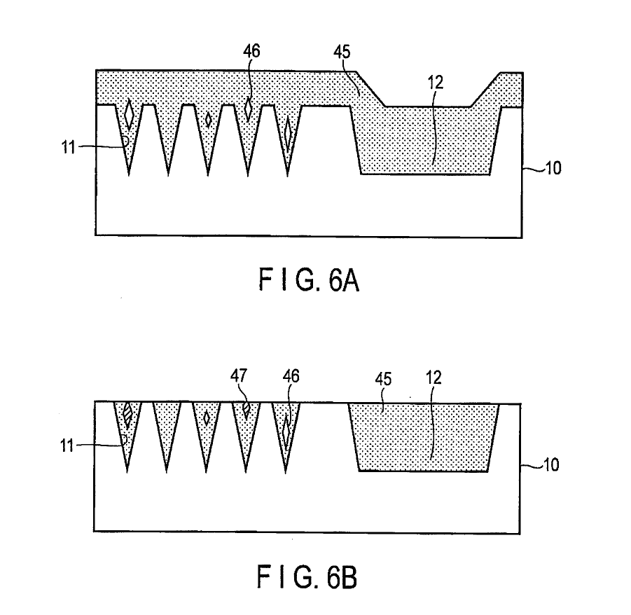

A conventional method of filling a trench pattern provided on the surface of a substrate with insulating layers will be explained with reference to FIGS. 6A and 6B, in comparison with the methods according to the embodiments.

FIG. 6A shows a SiO₂ film 45 formed by CVD on the surface of a substrate 10 that has a trench pattern. The broad trench 12 of the trench pattern is filled with the SiO₂ film 45. In the narrow trenches 11, however, a space 46 exits. The width and height of the space 46 depend also on the width and depth of the narrow trenches 11. The shape of each narrow trench is determined not only by the conditions of the RIE, but also by the peripheral pattern layout. Consequently, it is difficult to impart exactly the same width or the same height to the spaces 46.

FIG. 6B shows the state the product assumes after the SiO₂ film 45 having such irregular spaces 46 has been removed by the CMP process. Any space 46 that has its upper end at a level higher than the surface of the silicon substrate is clogged with slurry 47. This is because the slurry 47 used in the CMP process has entered the space 46. The slurry, which stays in the space 46, not only hinders the space making, but also causes the contamination of the slurry components ultimately impairing the device characteristics. That is, the slurry results in a great problem.

Thus, both a step of forming films and a step of performing CMP must be performed in the conventional method. The conventional method is inevitably complex. Further, it desired that spaces should be made to provide an air gap structure in order to enhance the device characteristics. If the spaces are made by forming films, however, it is difficult to control the air gap structure. Still further, the contamination of the slurry components will cause the degradation of the device characteristics.

By contrast, in this embodiment, the solvent 42 containing hollow fine particles 44 is supplied to the substrate 10 and the solvent holding member 22 is rotated while pressed onto the surface of the substrate. The solvent 42 containing fine particles 44 can thereby be filled in only the trenches 11 and 12. Since the fine particles 44 have a space in each, they serve as buried insulating films in the same way as in an air gap structure, and can therefore decrease the dielectric. In addition, the air gap structure can be well controlled only if the size of the spaces in the fine particles 44 is set to a specific value. This is because the air gap structure depends on the size of these spaces in the fine particles.

In this embodiment, the supplying of the solvent 42 containing hollow fine particles 44 and the filling of the trenches by using the solvent holding member 22 can thus be performed at the same time. The step of forming buried insulating films can therefore be simplified. Further, the air gap structure can be controlled at the buried insulating films. Still further, the embodiment is advantageous in that the device characteristics are prevented from being degraded due to slurry component contamination.

### Fifth Embodiment

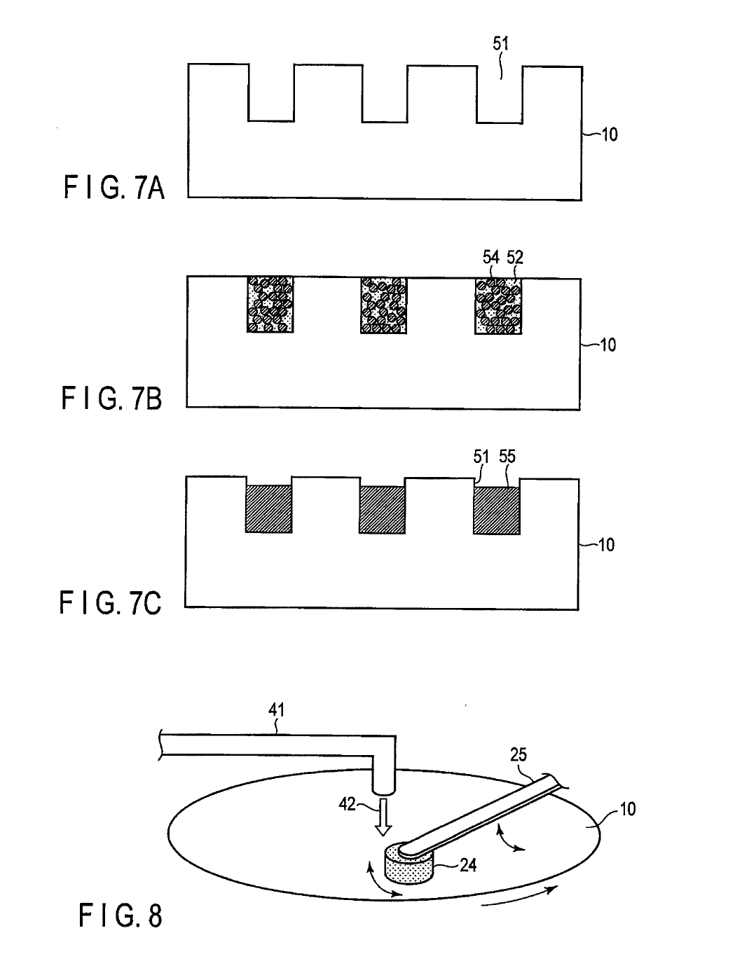

FIGS. 7A to 7C are sectional views showing steps of manufacturing a semiconductor device according to a fifth embodiment. This embodiment is a method of forming a trench interconnect pattern on a surface of a substrate.

As shown in FIG. 7A, an interconnect pattern 51 is formed on the surface of a Si substrate 10 by means of a photolithography process and a RIE process.

In this embodiment, an ethanol-based solvent containing, for example, fine particles 54 of metal oxide is used as solvent 52 that will form interconnect layers in trenches 51.

Next, the apparatus shown in FIG. 1 is used, setting the substrate 10 on the holder 30 and in contact with the solvent holding member 22, with the substrate 10 turned downwards. Then, the surface plate 21 and the holder 30 are rotated together, while the solvent 52 is being supplied from the solvent supplying nozzle 41. The solvent 52 can thereby be uniformly filled in the trenches 51 of the substrate 10 at high efficiency, as shown in FIG. 7B.

Then, the product is annealed in hydrogen, performing a reduction process. The solvent 52 is thereby evaporated and, at the same time, the fine particles are combined to one another as shown in FIG. 7C, thereby lowering the resistance. As a result, buried interconnect layers 55 are formed.

Thus, the solvent 52 containing fine particles 54 of metal oxide or the like can be filled in the trenches 51 in this embodiment, by virtue of the rotation of the substrate 10 and solvent holding member 22. Therefore, the buried interconnect layers 55 can be formed in the trenches 51 made in the substrate surface, without performing a process such as CMP. That is, the same apparatus can form films in the trenches 51 and remove the solvent from outside the trenches 51. This can shorten the manufacturing time and reduce the manufacturing cost.

### Modified Embodiment

This invention is not limited to the embodiments described above.

The solvent filling apparatuses shown in FIG. 1 to FIG. 3 are no more than exemplary ones. The invention is not limited to these apparatuses. Any apparatus that has a mechanism for holding and rotating the substrate, a mechanism for rotating the solvent holding member, a mechanism for supplying the solvent to the surface of the substrate can be used. The mechanism for supplying the solvent to the surface of the substrate may be not only a type that drips the solvent directly to the surface of the substrate as shown in FIG. 3, but also a type that drips the solvent to the surface of the solvent holding member as shown in FIG. 1 and FIG. 2.

In any embodiment described above, the solvent holding member is rotated along with the substrate. Nonetheless, the solvent holding member need not be rotated by all means.

For example, in an apparatus similar in configuration to the apparatus of FIG. 2, a solvent holding member 23 having a length equal to or larger than the radius of the substrate 10, for example, is arranged, extending from the center of the substrate to the outer circumference thereof. Then, the solvent 42 is supplied from the nozzle 41 to that part of the substrate, which is near the center of the substrate. While the substrate 10 is rotating, the solvent 42 spreads toward the outer circumference of the substrate. The solvent 42 can therefore be supplied to the entire surface of the substrate by virtue of the centrifugal force, even if the solvent holding member 23 is not rotated at all. Further, the solvent 42 can be filled in all trenches of the substrate 10 only if the solvent holding member 23 is pressed onto the substrate 10.

Moreover, as shown in FIG. 8, even a small solvent holding member 24 can press the entire surface of the substrate 10 if it is reciprocated in the radial direction of the substrate 10, between the center of the substrate 10 and the outer circumference thereof. The solvent holding member 24 can therefore serve to fill the solvent 42 in the trenches of the substrate 10.

In any embodiment described above, the fine particles used are made of Si or metal oxide. Nonetheless, the material of the fine particles can be changed, as needed, in accordance with the specification of the semiconductor device to manufacture. Further, the solvent, which will form an optical component, can contain fine particles that maintain desirable characteristics such as refractive index and transmittance and strength. Still further, the solvent is not limited to one containing fine particles. The trenches may, of course, be filled with solvent containing no file particles.

The embodiments described above are methods applied to the manufacture of semiconductor devices. Nevertheless, this invention can be applied not only to the manufacture of semiconductor devices, in which the trenches of a substrate must be filled with material other than that of the substrate.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A substrate processing method comprising:
supplying a solvent to a surface of a substrate having trenches; and
rotating the substrate, making a solvent holding member and the substrate slide on each other, while keeping the solvent holding member made of elastic material in contact with the surface of the substrate;

2. The method of claim 1, wherein the solvent holding member is rotated while the substrate is being rotated.

3. The method of claim 1, wherein the solvent holding member is reciprocated in a radial direction of the substrate while the substrate is being rotated.

4. The method of claim 2, wherein the rotating of the substrate and the solvent holding member and the supplying of the solvent are performed at the same time or alternately.

5. The method of claim 2, wherein the solvent holding member is shaped like a disc, and the substrate and the solvent holding member have rotation axes parallel to each other and spaced apart from each other.

6. The method of claim 5, wherein the solvent holding member has a diameter smaller than a diameter of the substrate, is secured to a distal end of an arm, and is moved parallel to the surface of the substrate.

7. The method of claim 2, wherein the solvent holding member is shaped like a pillar, and an axis of rotation of the substrate and an axis of rotation of the solvent holding member are orthogonal to each other.

8. The method of claim 1, wherein the solvent contains fine particles.

9. The method of claim 8, wherein the fine particles have a hollow structure.

10. The method of claim 1, wherein supplying the solvent to the surface of the substrate comprises dripping the solvent onto the solvent holding member and bringing the solvent held by the solvent holding member into contact with the surface of the substrate.

11. A substrate processing apparatus comprising:
a first rotation mechanism configured to hold a substrate having trenches made in a surface and to rotate the substrate around an axis perpendicular to the substrate;
a solvent holding member configured to contact the surface of the substrate and made of elastic material; and
a solvent supplying mechanism configured to supply a solvent to the surface of the substrate.

12. The apparatus of claim 11, further comprising a second rotation mechanism configured to hold and rotate the solvent holding member.

13. The apparatus of claim 11, further comprising a mechanism configured to hold and reciprocate the solvent holding member in a radial direction of the substrate.

14. The apparatus of claim 12, wherein the rotating of the substrate and the solvent holding member and the supplying of the solvent are performed at the same time by the first and second rotation mechanisms, respectively.

15. The apparatus of claim 12, wherein the rotating of the substrate and the solvent holding member and the supplying of the solvent are performed alternately by the first and second rotation mechanisms, respectively.

16. The apparatus of claim 12, wherein the solvent holding member is shaped like a disc, and an axis of rotation of the first rotation mechanism and an axis of rotation of the second rotation mechanism are parallel to each other and spaced apart from each other.

17. The apparatus of claim 16, wherein the solvent holding member has a diameter smaller than a diameter of the substrate, is secured to a distal end of an arm, and is moved parallel to the surface of the substrate.

18. The apparatus of claim 12, wherein the solvent holding member is shaped like a pillar, and an axis of rotation of the first rotation mechanism and an axis of rotation of the second rotation mechanism are orthogonal to each other.

19. The apparatus of claim 11, wherein the solvent contains fine particles.

20. The apparatus of claim 12, wherein the solvent supplying mechanism is further configured to drip the solvent onto the solvent holding member, and the solvent is supplied to the substrate by contact between the solvent holding member and the substrate.
